(19) United States
(12) Patent Application Publication
(10) Pub. No.: US 2012/0045157 A1
(43) Pub. Date: Feb. 23, 2012

(54) END CAP FOR A BEARING ASSEMBLY

(75) Inventor: Werner Guilford, Hulmeville, PA (US)

(73) Assignee: ROLLER BEARING COMPANY OF AMERICA, INC., Oxford, CT (US)

(21) Appl. No.: 13/290,342

(22) Filed: Nov. 7, 2011

Related U.S. Application Data
(62) Division of application No. 12/062,841, filed on Apr. 4, 2008.
(60) Provisional application No. 60/921,949, filed on Apr. 4, 2007.

(51) Int. Cl. F16C 33/78

(52) U.S. Cl. 384/489

(57) ABSTRACT

An end cap for a bearing assembly including a first body section being substantially symmetric about a central axis of the end cap and having a first seating surface defining an opening extending through the first body section coaxially with the central axis. The end cap includes a second body section extending away from the first seating surface and terminating at a second seating surface. The opening is operable to receive a portion of an inner member of the bearing assembly. The first seating surface is operable to engage a portion of the inner member and the second seating surface is operable to slidingly engage a portion of an outer ring which is disposed around a portion of the inner member.

### CROSS-REFERENCE TO RELATED APPLICATION

This application is a divisional of U.S. patent application Ser. No. 12/062,841, filed Apr. 4, 2008 and which claims the benefit of U.S. provisional application No. 60/921,949 filed Apr. 4, 2007, both of which are incorporated herein by reference in their entirety.

### FIELD OF THE INVENTION

The present invention is generally directed to an end cap with a retaining portion for a bearing and is more specifically directed to a light weight end cap having a retaining portion capable of removably securing the end cap to a bearing assembly and resisting inadvertent removal from the bearing.

### BACKGROUND OF THE INVENTION

Many types of bearings can be used to support radial, thrust, or combination radial and thrust loads. Such bearings include ball, roller, plain, journal and tapered roller types. To reduce friction, a lubricant such as a grease or oil can be introduced into the bearing.

Bearing performance can degrade, or severe and even catastrophic damage can occur, if insufficient lubricant is provided to the bearing. Where a bearing contains rolling elements, rotation of these rolling elements can act to pump lubricant out of the bearing. In addition, bearing performance can be detrimentally affected as a result of contamination of the lubricant and/or the introduction of foreign matter into the bearing. Seals have been used to help retain the lubricant within the bearing and to minimize contamination and foreign matter from entering therein. Such seals are typically made from a resiliently compliant material such as rubber, synthetic rubber or a composition thereof, such as Viton®.

A fitting, such as a grease fitting, can be positioned accordingly to provide a location for the introduction of the lubricant into the bearing.

### SUMMARY OF THE INVENTION

According to a first aspect of the present invention, an end cap for a bearing includes a first body section which is substantially symmetric about a central axis of the end cap. The end cap has a first seating surface defining an opening extending through the first body section coaxially with the central axis. The end cap also includes a second body section extending away from the first seating surface and terminating at a second seating surface. The opening is operable to receive a portion of an inner member of the bearing. The first seating surface is operable to engage a portion of the inner member. The second seating surface is operable to slidingly engage a portion of an outer ring which is disposed around a portion of the inner member.

The end cap can be made from a resilient plastic, a resilient metal or a resilient composite material.

According to another aspect of the present invention, a bearing includes an outer ring having a substantially cylindrical internal bearing surface and an inner member having a substantially cylindrical external bearing surface. A portion of the inner member is coaxially disposed within the outer ring. The external bearing surface and the internal bearing surface cooperate to define an annular cavity therebetween. A plurality of rolling elements is disposed within the annular cavity. The rolling elements are in rolling engagement with the external bearing surface and the internal bearing surface. The inner member defines a recess for engaging a portion of an end cap, as described further below.

In addition, the bearing includes an end cap defined by a first body section which is substantially symmetric about a central axis of the end cap. The first body section also has a first seating surface which defines an opening extending through the first body section coaxially with the central axis. The end cap also defines a second body section extending away from the first seating surface and terminating at a second seating surface. A portion of the inner member is positioned in the opening with the first seating surface being seated in the recess of the inner member. The second seating surface engages a portion of the outer ring. The end cap extends between the inner member and the outer ring.

In one embodiment, the recess of the inner member defines a circumferential groove in which the first seating surface is disposed. The groove can be located on a portion of the inner member positioned outside of the outer ring.

In another embodiment, the outer ring defines a recess in which the second seating surface is sealingly engaged.

In addition, the first seating surface and the second seating surface can be substantially perpendicular to one another.

### DESCRIPTION OF THE DRAWINGS

FIG. 1 is a cross sectional side view of a shaft and bearing assembly including an end cap in accordance with an embodiment of the present invention.

FIG. 2 is a cross sectional view of the end cap and a cut away portion of the shaft of the assembly of FIG. 1, wherein the end cap is inserted into the shaft.

FIG. 3 is an end view of the end cap of FIG. 2.

FIG. 4 is a cross sectional view similar to FIG. 2, but with end cap only partially inserted into the shaft, so that the detent member is in a compressed state.

FIG. 4A is a detail view of a part of FIG. 2.

FIG. 5 is a cross sectional view of the end cap with a shank having a through-bore, inserted into a shaft.

FIG. 6 is a cross sectional view of an end cap including a castellated shank having a through-bore.

FIG. 7 is an end view of the end cap of FIG. 6.

FIG. 8 is a cross sectional view of the end cap including a castellated shank having a through-bore and outwardly projecting protrusions extending therefrom.

FIG. 9 is a partial cross sectional view of an end cap installed on a bearing assembly in accordance with another embodiment of the invention.

FIG. 10 is a cross sectional view of the end cap of FIG. 9.

FIG. 11 is a bottom view of the end cap of FIG. 10.

FIG. 12 is a detail view of a portion of FIG. 9.

FIG. 13 is a detail view of the seating portion in the outer ring shown in FIG. 9.

FIG. 13A is a partial cross sectional view of an end cap installed on a bearing assembly in accordance with another embodiment of the invention.

FIG. 14 is a cross sectional view of an end cap including a castellated retaining portion according to another embodiment of the invention.

FIG. 15 is a bottom view of the end cap of FIG. 14.

FIG. 16A is a schematic cross-sectional view of a shaft and bearing assembly with an end cap according to yet another embodiment of this invention.

FIG. 16B is a detail view of a portion of FIG. 16A.

FIG. 17 is a schematic cross-sectional view of a shaft and bearing assembly with an end cap according to yet another embodiment of this invention

### DETAILED DESCRIPTION

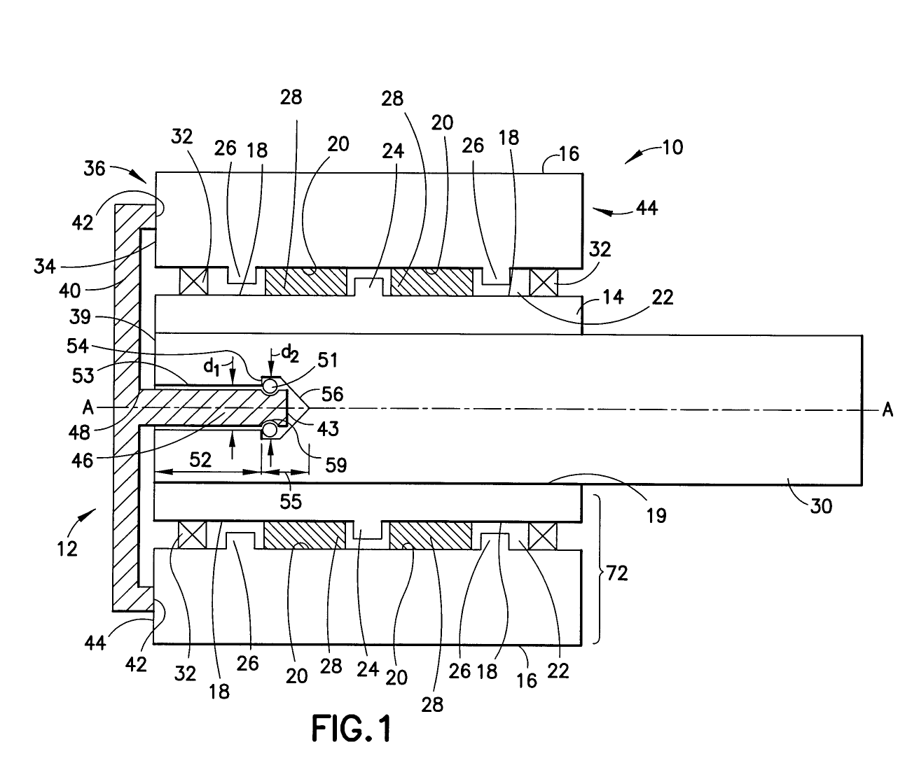

As shown in FIG. 1, a shaft and bearing assembly generally designated by the reference numeral 10 has an end cap 12 mounted thereon. The shaft and bearing assembly 10, may be a cam follower or a yoke roller or the like. The shaft and bearing assembly 10 is composed of a substantially cylindrical shaft 30 and a bearing 72 mounted thereon. The bearing 72 includes an outer ring 16 and an inner bearing, for example, an inner ring 14. A plurality of rolling elements 28 is positioned between the outer ring 16 and the inner ring 14. The inner ring 14 has a substantially cylindrical external bearing surface 18 including at least one outwardly projecting shoulder 24. The inner ring 14 includes a substantially cylindrical inner wall 19 defining a bore which extends through the inner ring. The outer ring 16 of the bearing 72 has a substantially cylindrical internal bearing surface 20 including at least one inwardly projecting shoulder 26. The inner ring 14 is coaxially disposed within the outer ring 16. The inner ring 14 and the outer ring 16 cooperate to define an annular cavity 22 therebetween. A plurality of rolling elements 28, which may be needles, balls, rollers, or the like, are disposed in the annular cavity 22. The rolling elements 28 are in rolling engagement with the external bearing surface 18 and the internal bearing surface 20 so that the inner ring 14 and the outer ring 16 are rotatable relative to each other about their common axis A. The plurality of rolling elements 28 are positioned between the outwardly projecting shoulders 24 and the inwardly projecting shoulders 26. The bearing 72 also includes two seals 32 disposed between the external bearing surface 18 and the internal bearing surface 20 for retaining a lubricant within the annular cavity 22. One of the seals 32 is positioned at an outboard end 36 of the bearing 72 and another one of the seals 32 is positioned at an in-board end 44 of bearing. While two seals 32 have been shown and described, the present invention is not limited in this regard as less than or more than two seals can be employed without departing from the broader aspects of the present invention.

The portion of the shaft 30 disposed in the bore of the inner ring 14 is substantially cylindrical. The inner ring 14 may be pressed, shrunk, or otherwise secured onto the shaft 30. The inner ring 14 and the portion of the shaft 30 therein cooperate to form an inner bearing structure of the shaft and bearing assembly 10.

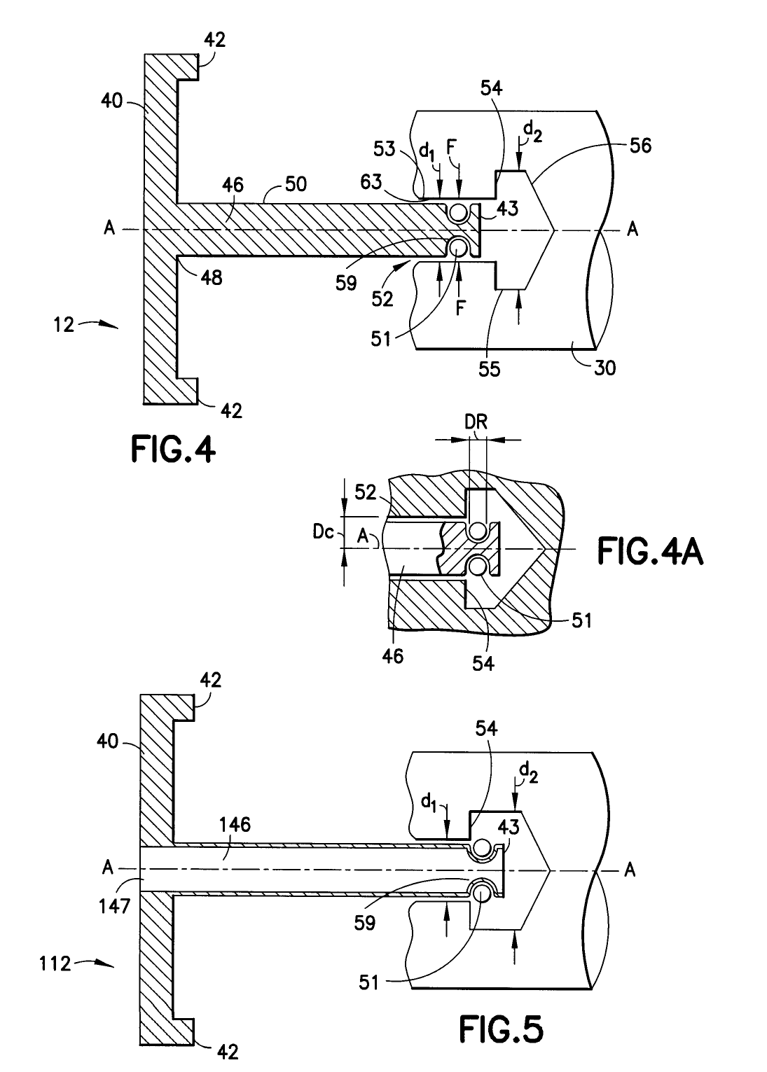

The shaft 30 has a bore 52 that is formed, cut or otherwise disposed in a distal end 39 of the shaft. The bore 52 has a first portion 53 that is adjacent to the distal end 39 of the shaft 30 and that has a diameter d1. A second portion 55 of the bore 52 is adjacent to the terminal end 56 of the bore and has a diameter d2. The diameter d2 is larger than d1, such that a shoulder 54 is defined in the bore 52 between the first portion 53 and the second portion 55, as seen in FIG. 4.

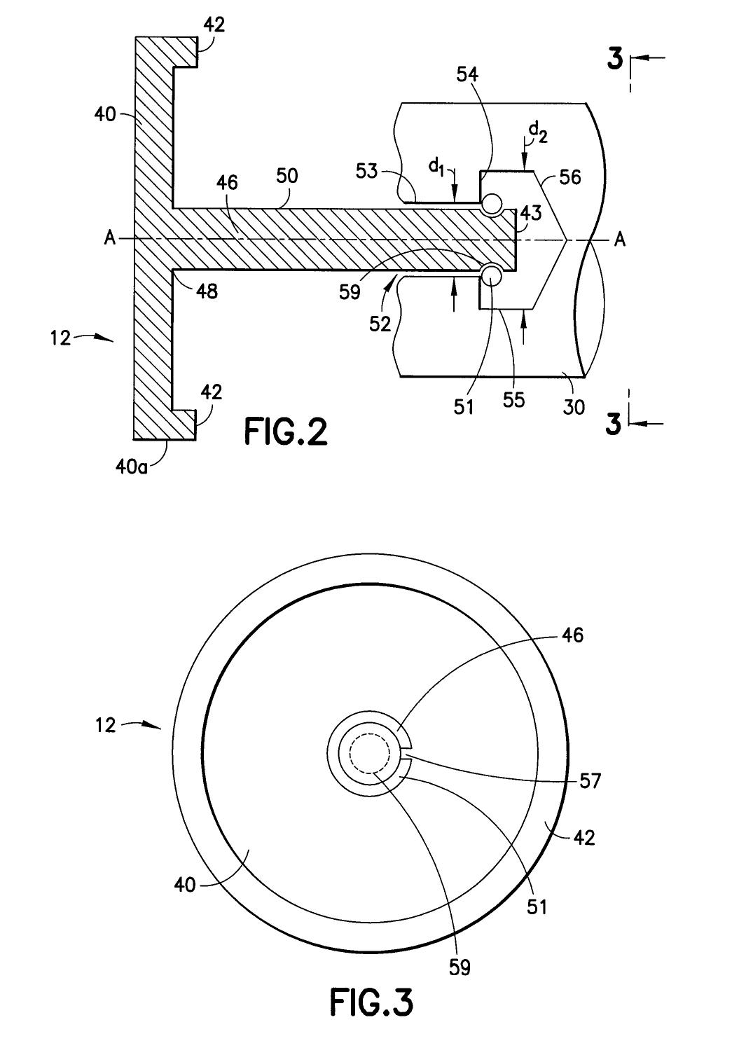

Referring to FIGS. 1-4, the end cap 12 has a body portion 40 that has an outer engagement portion and a central engagement portion. The outer engagement portion engages the outer ring of the bearing 72, and the central engagement portion engages the shaft 30 or inner ring 14. The engagement may be mutual surface contact that may inhibit the passage of particles, liquid and vapors therethrough (“sealing engagement”), or the engagement may be a mechanical coupling sufficient to retain the end cap 12 on the bearing 72 or on the shaft 30. Sealing engagement may include sliding contact between the mutually engaging structures. In the end cap 12, the central engagement portion includes a substantially cylindrical shank 46 projecting outwardly from the body portion. The shank 46 has a first end 43 which defines a circumferential seating groove 59 for receiving a resilient split ring 51 having a gap 57 (FIG. 3) defined thereby.

The split ring 51 is configured to have, in a relaxed state, an outside diameter that exceeds the diameter d1 in the bore 52 and an inside diameter that does not exceed the diameter of the shank 46 (so that even in the relaxed state, the split ring 51 remains seated in the seating groove 59). In addition, the split ring 51 and the seating groove 59 are configured so that the split ring can be compressed to conform to a diameter dl. When the shank 46 is inserted into the shaft 30, the inner wall 63 of the first portion 53 of the bore 52 applies a force F (indicated in FIG. 4) on the split ring 51 that causes the split ring to compress, thus allowing the split ring 51 to advance through the first section 53 to the second section 55. In the second section 55, the split ring 51 expands and inhibits the withdrawal of the shank 46 from the bore 52 by bearing against the shoulder 54. Thus, the split ring 51 and the second section 55 and the shoulder 54 function as a seat on the shaft for engaging the split ring 51 and together cooperate to for a detent mechanism. In this way, the shank 46 mechanically couples the end cap 12 to the shaft 30 without the need for supplemental mounting means such as screws, bolts, adhesive, etc.

Preferably, the shank 46 releasably engages the seating portion so that the end cap 12 can be removed from the shaft and bearing assembly 10 and may then be replaced, e.g., to temporarily expose the end of the shaft 30 and the outboard end 36 of the bearing 72 for inspection, maintenance or any other purpose. For example, the split ring 51 contacts the shoulder 54 at a point near its circumferential perimeter, i.e., at a radial distance Dc from the axis A to a point on the split ring beyond the greatest diameter DR of the split ring measured parallel to the axis A, as seen in FIG. 4A. An adequate withdrawal force can then cause the split ring 51 to again compress and allow the shank 46 to be withdrawn from the shaft 30, thus allowing the end cap to be removed from the shaft and bearing assembly 10. Alternatively, or in addition to contacting the split spring 51 as just described, the shoulder 54 may be slanted so that the shoulder acts as the surface of a cam that compresses the split spring as the end cap 12 is withdrawn from the bore 52.

The body portion 40 of the end cap 12 has a disc-like configuration which extends from the central engaging portion (i.e., from the shank 46) radially outward, across the annular cavity to an outer engagement portion 42 disposed thereon which sealingly engages the mating surface 34 of the outer ring 16. Thus, the end cap 12 provides a barrier to the introduction of contamination and foreign matter into the annular cavity 22.

Although the detent mechanism is shown as a split ring 51 fitted into a seating groove 59, the present invention is not limited in this regard, as other suitable detent mechanisms can be used to mechanically couple the end cap 12 to the shaft and bearing assembly 10, including but not limited to ball and spring mechanisms, protrusions or resilient fingers projecting outwardly from the outer surface 50, or a combination thereof. Furthermore, the seat on the shaft and bearing assembly 10 that engages the detent member may be a detent-receiving groove of any form suitable to the detent member. Moreover, although a detent mechanism is shown and described, the present invention is not limited in this regard, as it will be apparent to one of ordinary skill in the art that the engagement portion on the end cap 12 that mechanically couples the end cap to the shaft and bearing assembly 10 may comprise a seating portion for a detent on the shaft and bearing assembly.

While the shank 46 has been described above as being substantially cylindrical, the present invention is not limited in this regard as the shank can be of any suitable cross-sectional shape including but not limited to hexagonal, square and star-shaped cross sections. The end cap 12 can be manufactured from a resilient plastic material such as polyurethane and the split ring 51 can be manufactured from spring steel, however, the invention is not limited in this regard as other materials may be used for the end cap 12, including but not limited to metals, composite materials and combinations thereof, and/or other materials may be used for the split spring 51 or other detents, including but not limited to other metals, composite materials and combinations thereof.

While the bearing 72 is shown with two sets of rolling elements 28 separated by a shoulder 24 that projects from the inner ring 14, this is not a limitation on the invention, and various other configurations of bearings, rolling elements, etc. are known in the art and, in view of the disclosure herein, all such bearings and shaft and bearing assemblies can employ an end cap as described herein.

The end cap 112 shown in FIG. 5 is similar in configuration to the end cap 12 shown in FIGS. 1-4, and the foregoing description of end cap 12 will apply to end cap 112 correspondingly, with the following differences. The end cap 112 has a hollow shank 146 which defines a passage 147 that extends from the first end 43 of the shank to the second end 48 and through the body portion 40. The shank 146 sealingly engages the inner wall 63. The passage 147 allows the escape of air from the bore 52 to avoid compressing air therein while the end cap 112 is mounted on the shaft and bearing assembly 10.

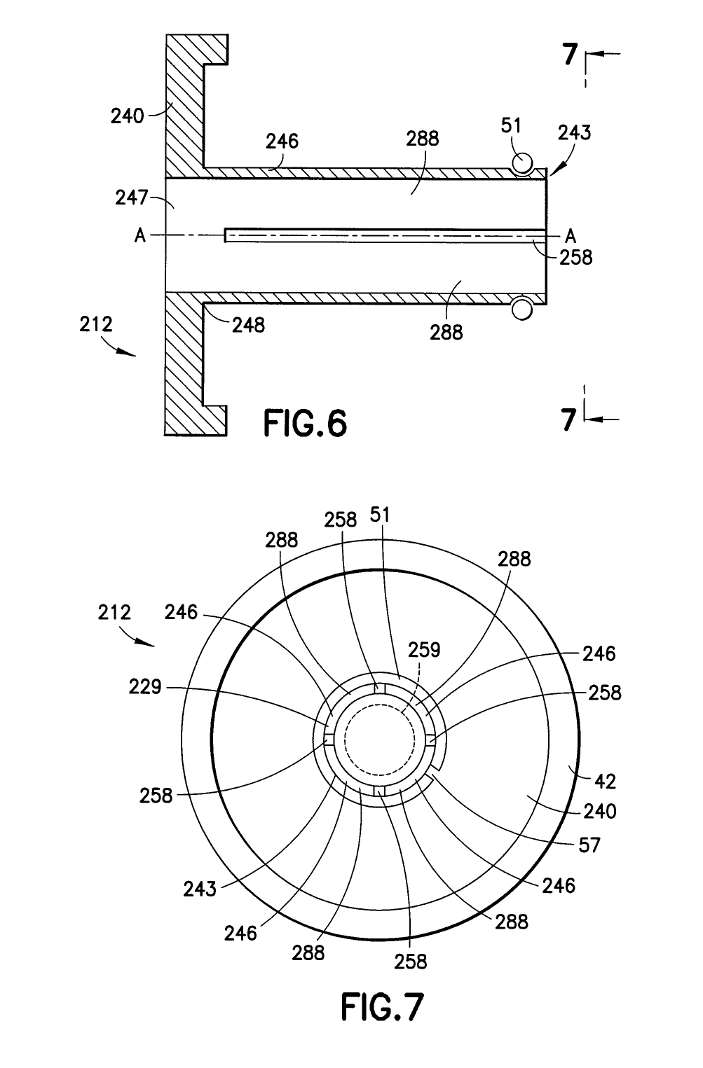

The end cap 212 shown in FIGS. 6 and 7 is similar in configuration to the end cap 112 shown in FIG. 5, and the foregoing description of end cap 112 will apply to end cap 212 correspondingly, with the following differences. The end cap 212 includes a shank 246 which is a substantially hollow cylindrical shell open on opposing ends and defining a passage 247 extending therethrough. The shank 246 includes a castellated portion defined by a plurality of slits 258 formed at the first end 243 and terminating between the first end and the second end 248. The slits 258 define a plurality of shank segments 288. The slits 258 allow the shank segments 288 to flex when sliding the shank 246 into the shaft 30 to engage the seating portion in the shaft.

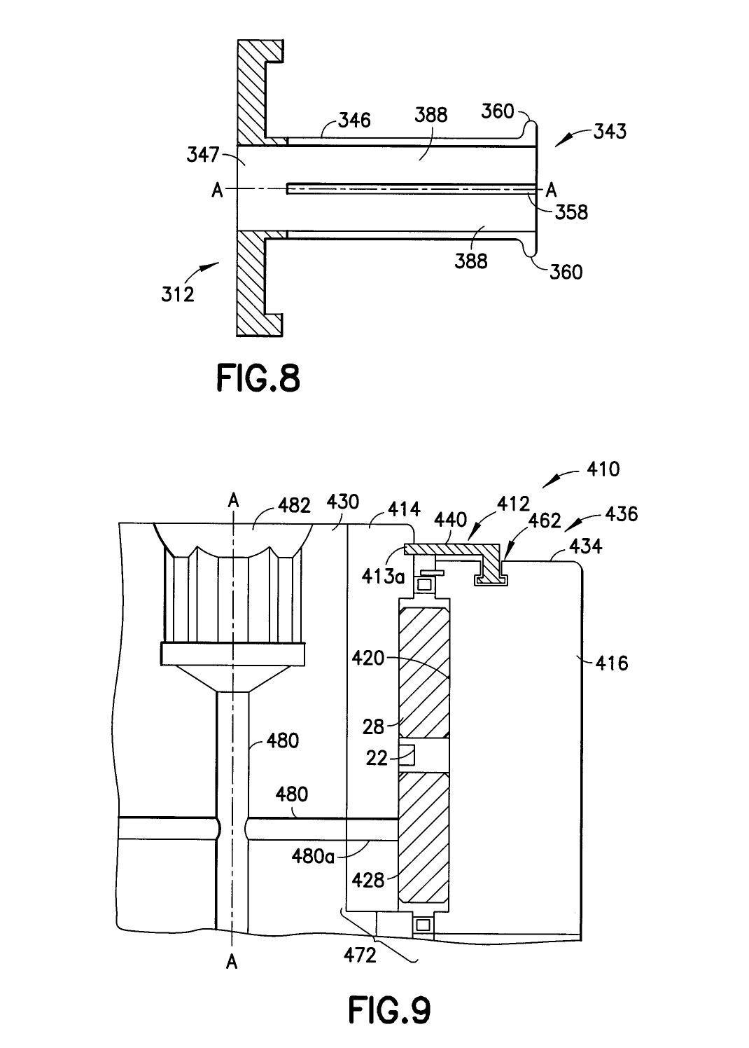

The end cap 312 shown in FIG. 8 is similar in configuration to the end cap 212 shown in FIGS. 6 and 7, the foregoing description of end cap 12 will apply to end cap 312 correspondingly, with the following differences. The end cap 312 includes a shank 346 which is a substantially hollow cylindrical shell open on opposing ends and defining the passage 347 extending therethrough. The shank 346 further includes a castellated portion defined by a plurality of slits 358 formed in the first end 343 and defining a plurality of flexible shank segments 388. There is no split ring or seating groove to correspond to split ring 251 and seating groove 259, but the shank 346 includes detent members having protrusions 360 projecting outwardly from the shank segments 388, at the first end 343 of the shank. The protrusions 360 can engage the seating portion of the shaft and bearing assembly 10 in a manner similar to that described above for the split ring 51 of end cap 12.

The shaft and bearing assembly 410 shown in FIGS. 9-13 are similar in configuration to the shaft and bearing assembly 10 shown in FIGS. 1-4, the foregoing description of the shaft and bearing assembly 10 will apply to the shaft and bearing assembly 410 correspondingly, with the following differences. The outer ring 416 of the bearing assembly 410 defines a detent-receiving groove 462 disposed on an end 436 of the outer ring, to provide a seating portion. The detent-receiving groove 462 is disposed on an end surface 434 on an end 436 of the outer ring 416 which is substantially perpendicular to the axis A.

The detent-receiving groove 462 is formed, cut or otherwise disposed in the end 436 and defines a shoulder 464. The shoulder 464 is defined by a transition between a first section 466 of the detent-receiving groove 462 having an inside diameter d3 and a second section 468 of the detent-receiving groove 462 having an increased diameter d4 adjacent the terminal end 470 of the bore, wherein d4 is greater than d3.

The inner ring 414 extends axially towards the end of the shaft 430 than does the outer ring 416, so that part of the substantially cylindrical external bearing surface 418 extends beyond the annular cavity 422.

The end cap 412 on the shaft and bearing assembly 410 has a body portion 440 but no shaft portion. The end cap 412 is manufactured from a resilient plastic material such as polyurethane. The body portion 440 has an annular configuration having an inner portion 413a which provides the central engagement portion of the end cap 412. The annular inner portion 413a mechanically engages a groove (unnumbered) on the inner ring 414, the groove providing a seat for retaining the end cap 412 on the shaft and bearing assembly 410.

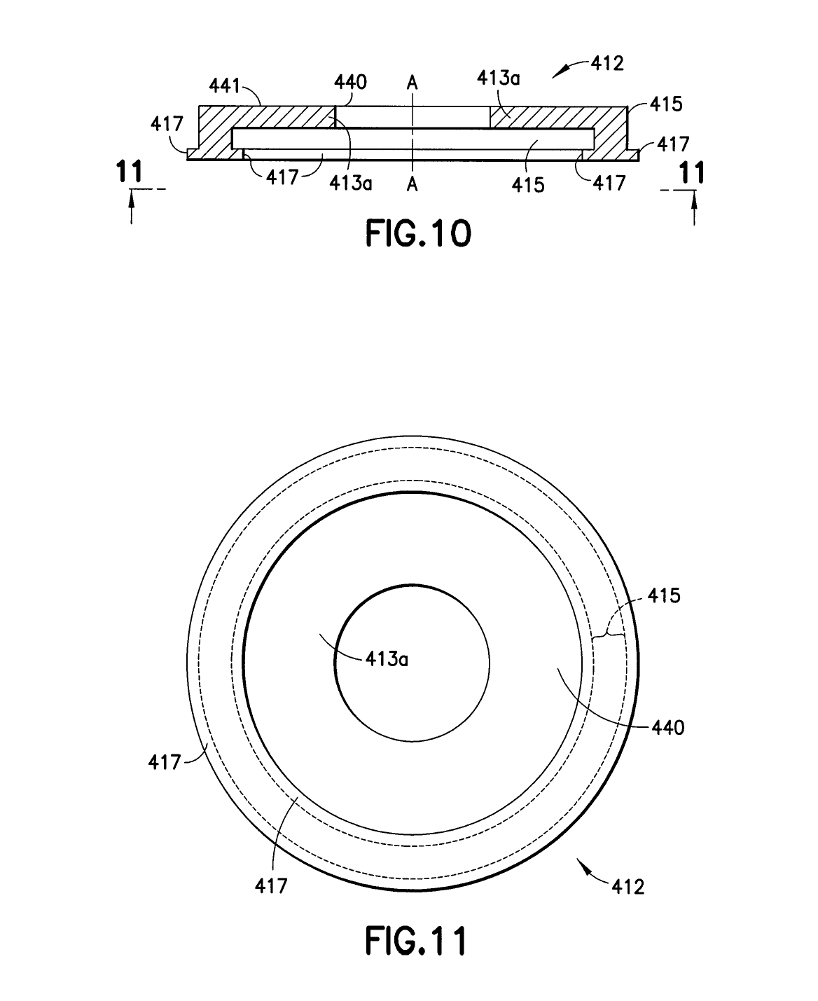

The end cap 412 includes a lip 415 (FIG. 10) to provide a retaining portion projecting from the body portion 440. The lip 415 is a resilient cylindrical shell disposed about a periphery of the body portion 440. The lip 415 includes a protrusion 417 to provide a detent member for sealingly and releasably securing the end cap 412 to a seating portion the bearing assembly 410.

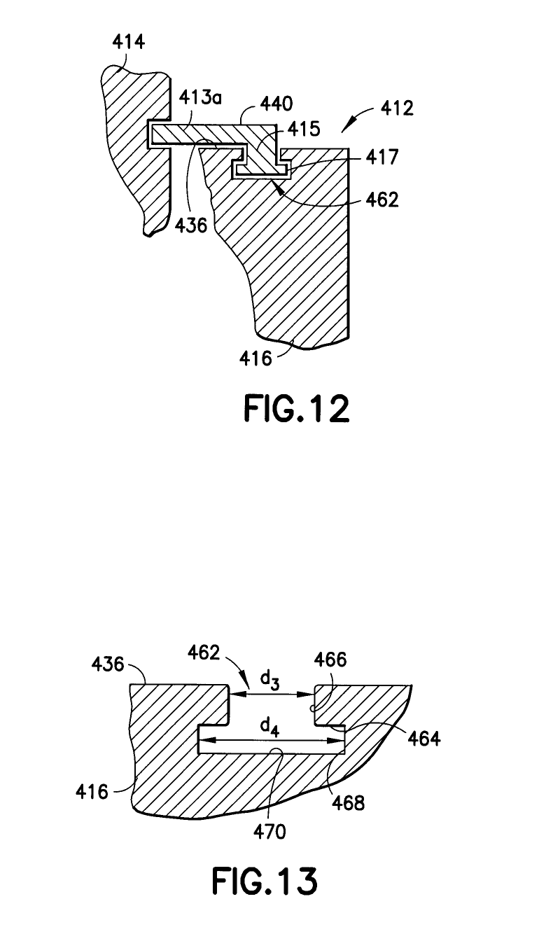

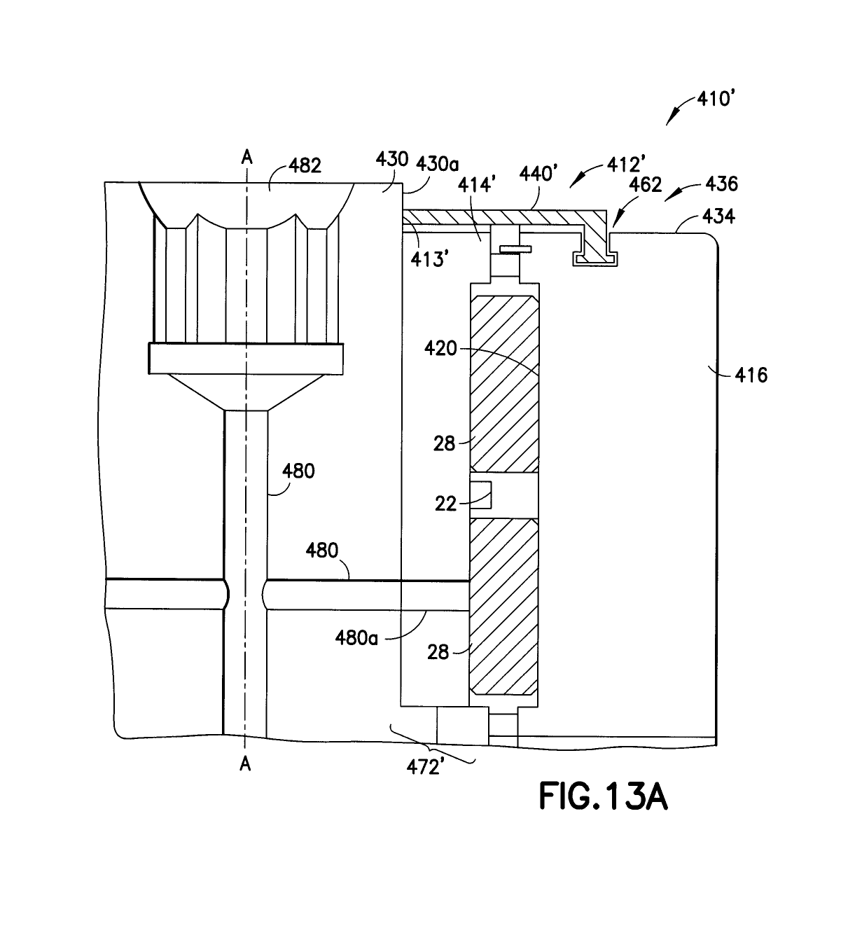

Referring to FIGS. 12 and 13, when the lip 415 is inserted into the detent-receiving groove 462 within the first section 466, a radially and inwardly directed reaction force applied by the detent-receiving groove 462 onto the protrusion 417 causes the lip 415 to deform and allows the lip 415 to travel into the bore. When the protrusion 417 moves into the second section 468, the protrusion 417 relaxes and abuts the shoulder 464 thus inhibiting removal of the lip 415 from the detent-receiving groove 462.

The shaft 430 includes flow paths 480 and a port 482 for conveying a lubricant to the annular cavity 422 via an inner ring flow path aperture 480a. In operation, the lubricant can by supplied to the bearing assembly 410 without removing the end cap 412.

While the end cap 412 is shown engaging inner ring 414, the present invention is not limited in this regard as an inside circumferential surface may alternatively engage a portion of a shaft in the bearing. For example, in the shaft and bearing assembly 410′ shown in FIG. 13A, which has generally the same configuration as the shaft and bearing assembly 410 shown in FIG. 9, the inner ring 414′ does not extend as far in the axial direction along the shaft 430 as the inner ring 414 of FIG. 9, and so the cylindrical mating portion 430a on the shaft is exposed. The end cap 412′ has a larger body portion 440′ than the body portion 440 of the end cap 412, and the larger body portion 440′ reaches over the inner ring 414′ from the outer ring 416 to engage the mating portion 430a.

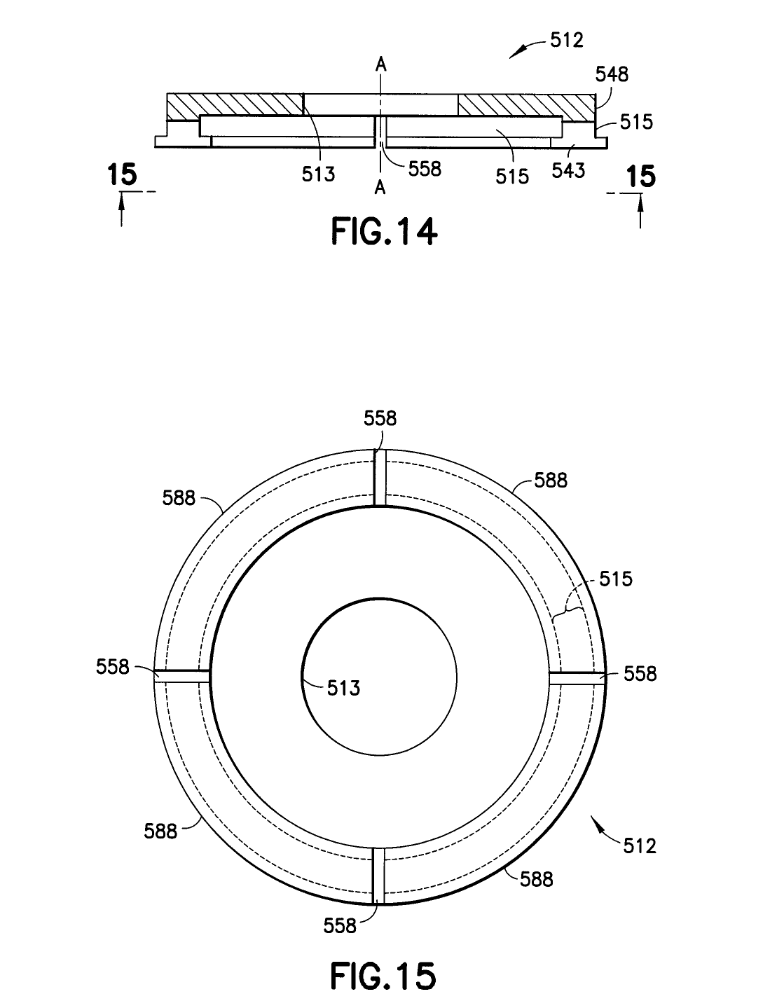

The end cap 512 shown in FIGS. 14 and 15 is similar in configuration to the end cap 412 shown in FIGS. 9-12, and the foregoing description of end cap 412 will apply to end cap 512 correspondingly, with the following differences. The lip 515 has a castellated configuration defined by a plurality of axially extending slits 558 formed, cut or otherwise disposed in the cylindrical shell and defining a plurality of segments 588 (FIG. 15). The slits 558 extend between the first end 543 and the second end 548 and allow the segments 588 to flex when sliding the lip 515 into the seating portion. The end cap 512 can be used on a shaft and bearing assembly in the same manner as end cap 414, e.g., in one embodiment the inside circumferential surface 513 may sealingly engage an inner ring 414 or a shaft 430.

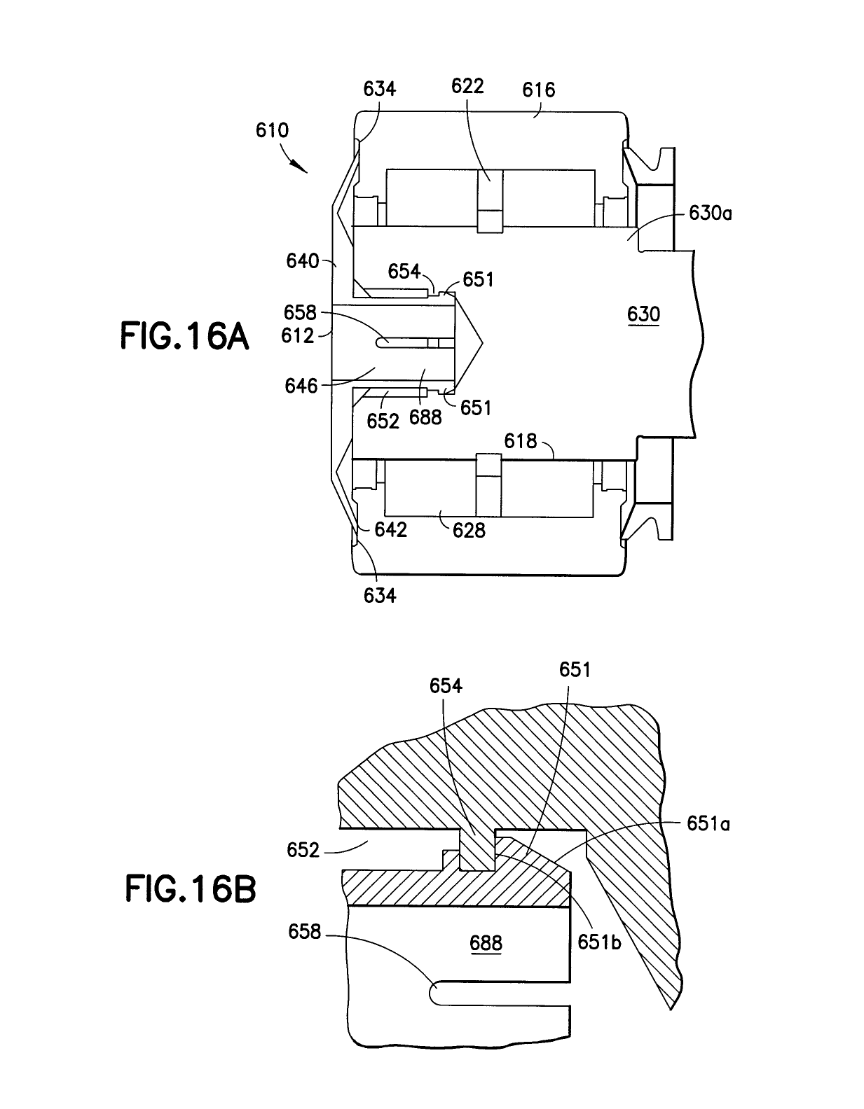

In another embodiment, the inner bearing structure is integral with the shaft, as seen in the shaft and bearing assembly 610 of FIG. 16. Accordingly, the outer ring 616 is coaxially disposed about the end of the shaft 630 to define an annular cavity 622 between the outer ring and a cylindrical stepped end portion 630a of the shaft. The cylindrical stepped end portion 630a of the shaft provides a substantially cylindrical external bearing surface 618, and the rolling elements 628 are disposed in the annular cavity in rolling contact with the outer ring 616 and the shaft 630. An end cap 612 is mounted on the shaft and bearing assembly 610. The end cap 612 has a body portion 640 that includes a shank 646 extending therefrom for insertion into a bore 652 in the end of the shaft 630. The bore 652 may have a hexagonal configuration. The shank 646 has a bore therethrough and has, at the insertion end, a castellated configuration provided by slits 658 that divide the shaft into flexible segments 688. The shank 646 includes barbs 651 on the flexible segments 688, and the bore 652 in the shaft 630 includes an internal rib or undercut 654 in the bore 652. As seen in FIG. 16B, each barb 651 has an outward-facing wedge surface 651a and a stop shoulder 651b. The barb 651 is configured so that as the end cap 612 is inserted into the bore 652, the wedge surface 651a engages the rib 654 and, as the shank 646 advances in the bore, the barb causes the segment on which it is disposed to flex inward. Then, once the shoulder 651b passes the rib 654, the segment flexes outward and the shoulder 651b engages the rib 654 to inhibit removal of the end cap 612 from the shaft 630. In this way, the shoulder 654 provides a seat for receiving the barb 651, whereby to retain the end cap 612 on the shaft and bearing assembly 610. The body portion 640 of the end cap 612 is configured so that when the barb 651 engages the rib 654, the body portion extends across the annular cavity 622 to where an annular sealing surface 642 on the body portion engages an annular recessed mating surface 634 on the outer ring 616.

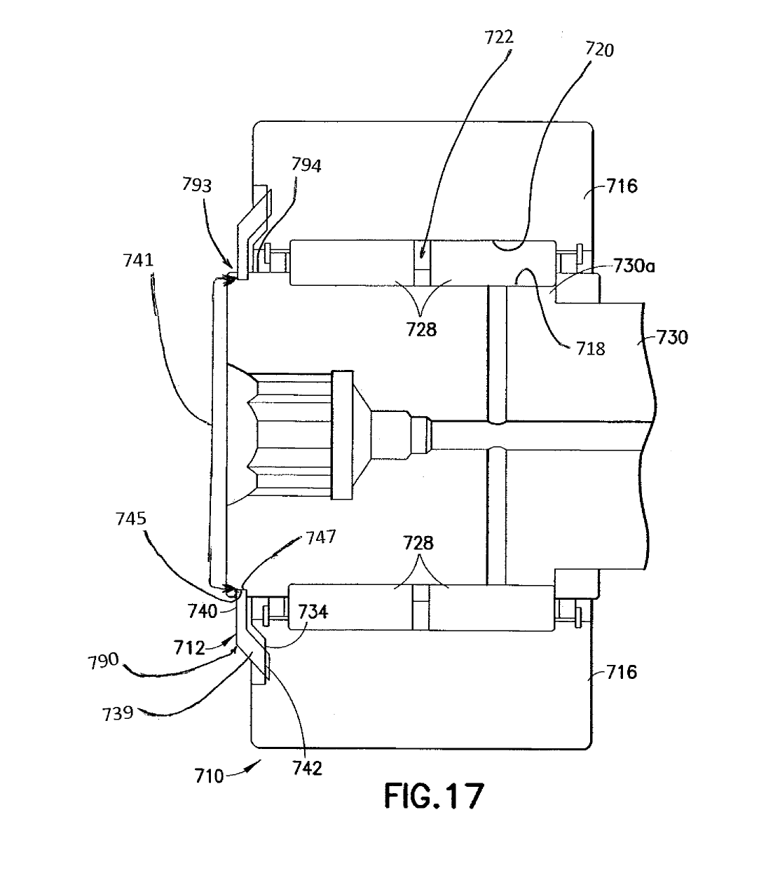

As illustrated in FIG. 17, the shaft and bearing assembly 710 includes an outer ring 716 having a substantially cylindrical internal bearing surface 720. A shaft 730 is coaxially disposed within the outer ring 716. The shaft 730 defines a stepped portion 730a which provides a substantially cylindrical external bearing surface 718. An annular cavity 722 is defined between the internal bearing surface 720 and the external bearing surface 718. A plurality of rolling elements 728 are disposed in the annular cavity 722. The rolling elements 728 rolling engage the internal bearing surface 720 and the external bearing surface 718.

A recessed mating surface 734, for example, a groove, is formed into a transverse end, for example an end face, of the outer ring 716 for receiving a portion of an end cap 710, as described below. An end portion 793 of the shaft 730 extends out of the outer ring 716. A portion of the shaft 730 adjacent to the end 793 defines an external surface 794. Another recessed mating surface 747, for example, a groove, is formed into the external surface 794 of the shaft 730.

The shaft and bearing assembly 710 also includes an end cap 712 which is removably disposed thereon. The end cap 712 defines a first body portion 740 that has a central opening 741 defined by a generally annular first seating surface 745 that is seated in the recessed mating surface 747 in the shaft 730. The end cap 712 includes a second body portion 739 which extends away from the first seating surface 745 and terminates at a substantially circular second seating surface 742. The second seating surface 742 sealingly and slidingly engages the recessed mating surface 734 on the end of the outer ring 716. The end cap 712 is illustrated having a bend 790 which defines the junction of the first body portion 740 and the second body portion 739. The bend 790 is configured to position the first seating surface 745 and the second seating surface 742 substantially perpendicular to one another.

While the central opening 741 is shown and described as being defined by a generally annular first seating surface 745, the present invention is not limited in this regard, as other shapes and configurations may be employed including but not limited to rectangular and hexagonal shapes. Although the second seating surface 742 is shown and described as being substantially circular, the present invention is not limited in this regard as other shapes and configurations may be employed including but not limited to hexagonal and elliptical shapes.

The end cap 712 can be manufactured from a resilient plastic material such as polyurethane, however, the invention is not limited in this regard as other materials may be used, including but not limited to metals, composite materials and combinations thereof.

The opening 741 is operable to receive an end of the shaft 730. In addition, during installation, the end cap 712 is elastically deformed by expanding the opening 741 onto the shaft 730. When the end cap 712 is installed on the shaft 730 with the second seating surface 745 removably secured and seated in the groove 747, the end cap returns to an un-deformed state.

Although the present invention has been disclosed and described with reference to certain embodiments thereof, it should be noted that other variations and modifications may be made, and it is intended that the following claims cover the variations and modifications within the true spirit of the invention.

What is claimed is:

1. An end cap for a bearing assembly, comprising:
a first body section being substantially symmetric about a central axis of the end cap and having a first seating surface defining an opening extending through the first body section coaxially with the central axis;
a second body section extending away from the first seating surface and terminating at a second seating surface;
the opening being operable to receive a portion of an inner member of the bearing assembly and the first seating surface being operable to engage a portion of the inner member; and
the second seating surface being operable to slidingly engage a portion of an outer ring disposed around a portion of the inner member.

2. The end cap of claim 1, comprising a bend between the first body section and the second body section.

3. The end cap of claim 1, comprising a resilient plastic material, a resilient metal or a resilient composite material.

4. The end cap of claim 1, wherein the second seating surface is substantially circular.

5. The end cap of claim 1, wherein the first seating surface and the second seating surface are substantially perpendicular to one another.

6. A bearing comprising:
an outer ring having a substantially cylindrical internal bearing surface;
an inner member coaxially disposed at least partially within the outer ring and having a substantially cylindrical external bearing surface and a first recess formed in the external bearing surface;
the external bearing surface and the internal bearing surface defining an annular cavity therebetween;
a plurality of rolling elements disposed within the annular cavity, the rolling elements being in rolling engagement with the external bearing surface and the internal bearing surface; and
an end cap having a first body section being substantially symmetric about a central axis of the end cap and having a first seating surface defining an opening extending through the first body section coaxially with the central axis, and a second body section extending away from the first seating surface and terminating at a second seating surface;
a portion of the inner member being positioned in the opening with the first seating surface being seated in the first recess;
the second seating surface being slidingly engaged with a portion of the outer ring; and
wherein the end cap extends between the inner member and the outer ring.

7. The bearing of claim 6, wherein the first recess defines a circumferential groove in which the first seating surface is disposed.

8. The bearing of claim 7, wherein the groove is located on a portion of the inner member positioned outside of the outer ring.

9. The bearing of claim 6, wherein an end portion of the outer ring defines a second recess which the second seating surface slidingly engages.

10. The bearing of claim 6, wherein the end cap comprises a resilient plastic, a resilient metal or a resilient composite material.

11. The bearing of claim 6, wherein the inner member is a shaft.

12. The bearing of claim 6, wherein the end cap comprises a bend between the first body section and the second body section.

13. The bearing of claim 6, wherein the second seating surface is substantially circular.

14. The bearing of claim 6, wherein the first seating surface and the second seating surface are substantially perpendicular to one another.
